(19) United States
(12) Patent Application Publication
(10) Pub. No.: US 2004/0095751 A1
(43) Pub. Date: May 20, 2004

(54) Net-shaped framework for three-dimensional decorative lighting

(76) Inventor: Wen-Hua Pan, Taipei City (TW)

Correspondence Address: BIRCH STEWART KOLASCH & BIRCH, PO BOX 747, FALLS CHURCH, VA, 22040-0747, US

(21) Appl. No.: 10/298,793

(22) Filed: Nov. 19, 2002

(51) Int. Cl. F21S 6/00

(52) U.S. Cl. 362/124; 362/226; 362/252; 362/806

(57) ABSTRACT

A net-shaped framework for three-dimensional decorative lightings comprises a structural body being assembled by a net support member. A net member formed by a group of cross-layout grid net, which is attached to said net support member, and at least one illumination element mounted in said structural body, whereby the different model of the net-shaped framework, the three-dimensional decorative lightings can further produce lifelike aspects, brilliant lights and visual effect which is more attractive than the conventional decorative lightings.

### FIELD OF THE INVENTION

The present invention relates to a net-shaped framework for three-dimensional decorative lightings and more particularly pertains to a new decorative lighting having free standing, three-dimensional net-shaped framework and light supporting display for use as a decoration.

### BACKGROUND OF THE INVENTION

Nowadays it is a common practice to decorate sites of festivals and conventions with ornamental articles to foster joyful atmosphere. Ornamental lights are indispensable articles for those events, especially for occasions such as flower lamps in Lantern festival, Christmas lights for Christmas, etc. In addition, in many family parties and gatherings for celebrating special events, decorative lightings are usually being used to augment the amusing and entertaining effect. Many people who care about quality of life also tend to decorate their houses with some sorts of ornamental lights. Hence to use lights for decorating purpose and employ special light brackets to hold and fasten lamps is well accepted and quite popular these days.

However, conventional decorative lightings are usually two-dimensional types with a lamp coupling to a fixed socket to achieve a secured positioning. They mostly offer a two-dimensional and wall decorating effect, but cannot stand by themselves. Comparing with three-dimensional decorative lighting, they are less exciting and do not have lively effect.

While conventional three-dimensional decorative lightings are largely grouped into the following types, i.e., a paper type, a plastic type, an embossed type and a semi-transparent film type. All of them are made in the form of a continuous sheet. Such continuous sheet structure, however do not provide the more realistic and lifelike displays, and there are still many problems in practical use, notably:

1. Conventional approaches of fastening lamps to three-dimensional decorative lightings by means of fastening bands often have allowances or gaps formed between the lamps and the decorative lightings. The lamps tend to loosen after being used for a period of time. As a result, the lamps tend to wobble even they are mounted to the three-dimensional decorative lightings.

2. In conventional three-dimensional decorative lightings, creases or air bubbles are apt to be produced within the sheet structures. Once produced, the creases or air bubbles should be removed by moving them, one by one, toward the sheet ends, or the sheet should be attached again after being removed. If the sheet surface is curved, such problem will be more serious.

3. In conventional three-dimensional decorative lightings, the sheet structure is easily fractured by external force.

4. In conventional three-dimensional decorative lightings, the sheet structure is a bad heat radiator, thus causing the temperature of the structure of the lighting to rise when used for a long period of time. In conventional three-dimensional decorative lightings, the sheet structure is not weather resisting, thus damages will form by bad weather, or the color of the structure will change due to the strong rays of sunlight.

### SUMMARY OF THE INVENTION

The primary object of the invention is to provide a free standing, three-dimensional net-shaped framework and provide the more realistic and lifelike light supporting display for use as a decoration.

Another object is to resolve aforesaid fastening problems incurred to conventional three-dimensional decorative lightings. The present invention provides a structural body for light bulbs, and mainly to prevent the light bulbs from being affected by external shaking forces and generate brilliant lights.

A further object of the invention is to enable the lamp held in the three-dimensional decorative lightings to generate light without scattering.

Still another object is to provide such a net-shaped framework and display, wherein the grid network of the structure is shaped into the form of a figure, such as animal, plant, vehicle or character.

In order to achieve the foregoing objects, the invention provides a decorative lighting with net-shaped framework includes a structural body being assembled by a net support member. A net member formed by a group of cross-layout grid net, which is attached to said net support member, and at least one illumination element mounted in said structural body, whereby the different model of the net-shaped framework, the three-dimensional decorative lightings can further produce lifelike aspects, brilliant lights and visual effect which is more attractive than the conventional decorative lightings.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1A is a perspective view of the present invention.

FIG. 1B is an exploded view of the present invention.

FIG. 1C is a schematic view of an enlarged portion of the present invention.

FIG. 1D is an exploded view of the present invention.

FIG. 2 is a schematic view of the invention appears in another structure.

### DESCRIPTION OF THE PREFERRED EMBODIMENTS

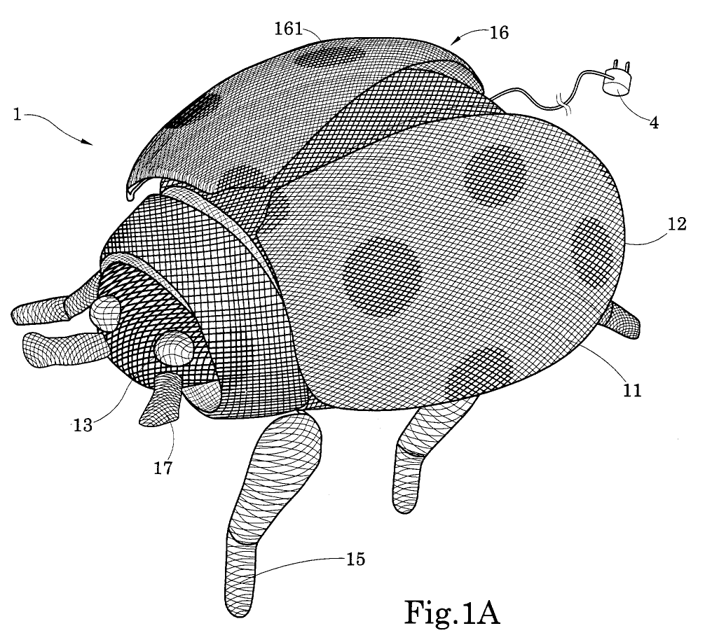

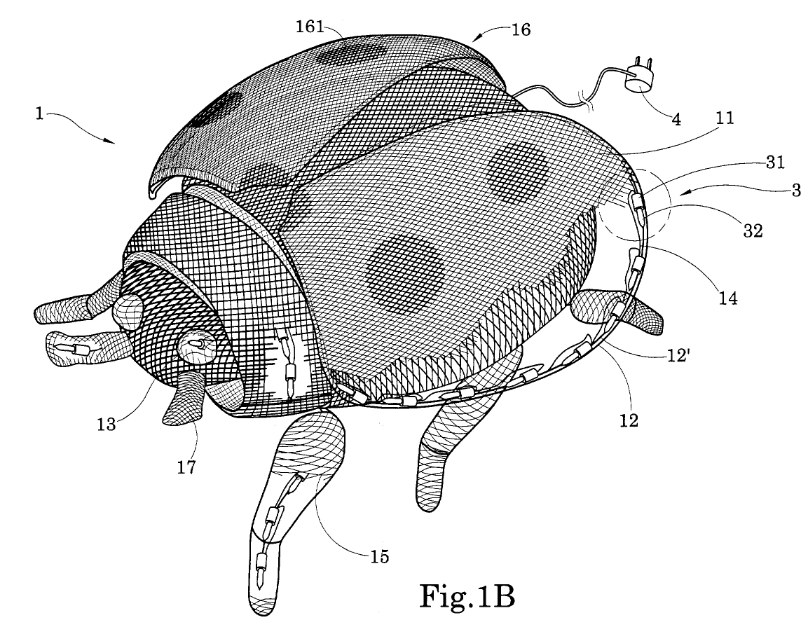

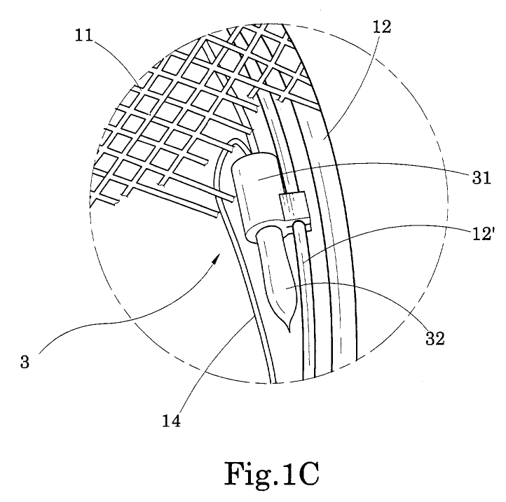

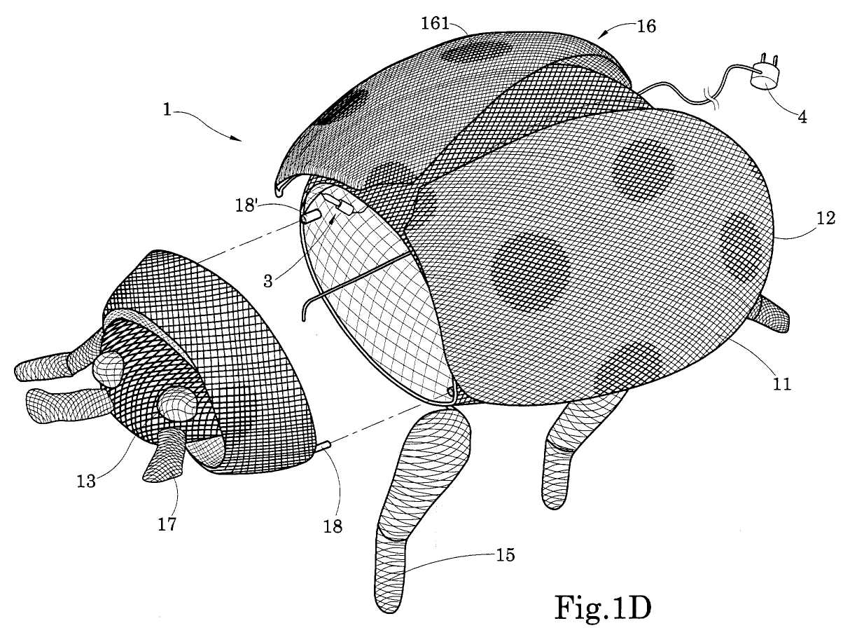

Referring to FIG. 1A, FIG. 1B, FIG. 1C and FIG. 1D, the present invention relates to a new appearance of a decorative lighting as a beetle-shape, the beetle-shaped decorative lighting which mainly includes a group of cross-layout grid net to form the arrangement of a net member 11, the edges of the above mentioned net member 11 is connected by a net support member 12. The net support member 12 forms a structural body 1, which utilizes a proper jig to attach at least one illumination element 3 to a fixed position. Thus, it can simply and easily be assembled as a firm structure of the decorative lighting, and it can be placed on any level ground to obtain the best effectiveness. When the electric plug 4 is switch to electricity, the structural body 1 of the beetle-shaped decorative lighting will start to shine in order to convey an atmosphere of joy during celebration moments and producing lifelike aspects, brilliant lights and visual effect.

The structural body 1 can be person body-like shaped, animal body-like shaped or vehicle-like shaped, which is form by injection into a continuous piece or it can be injected to form a plurality of separate pieces, thus the plurality of separate pieces of said structural body 1 is connected by hinges or loose-leaf binders. The structural body 1 also includes a plurality of auxiliary parts such as the head 13, the limbs 15, the mouth, the wings 16 of an animal, etc. The plurality of auxiliary parts are connected to the receiving members 18′ of the structural body 1 by fasteners, such as protruding members 18. For example, as shown on FIG. 1D, the receiving members 18′ is welded on the edge of the net support member 12 of the structural body 1 of the beetle-shaped decorative lighting, while the protruding members 18 are welded on the corresponding edge of as the head 13 of the beetle-shaped decorative lighting, users can separate the protruding members 18 departs from the receiving member 18′, in order to fix or repair or exchange the illumination element 3 mounted within the structural body 1.

The net member 11 is formed by metal thin chip punching or stamping process or plastic injection molding, and is made from a hot-melt resistant or high temperature resistant material. Through the process of punching and stamping, plurality of auxiliary parts of the structural body 1 such as the eye 13, the limbs 15, the wings 16 and the antenna 17 can be formed easily. The advantages of the net member 11 are that it is easy to keep the structural body 1 clean, the net member 11 is form by metal grid net member 11 which is less broken and less creased, while using stainless steel, the net member 11 is rust-proof thus the appearance will not be affected by weather changes. Furthermore, net member 11 are excellent in temperature, the net member 11 increases the total surface area of the structural body 1, which allows excellent heat radiation to the surrounding environment and weather resisting properties as in resistance to compression or tension or stretchability and the like.

The net support member 12 is form by wire, it is connected to the net member 11 by welding or by binding with fasteners.

The cross-layout grid net of the net member 11 can be painted or drawn with colors or patterns at one side thereof or at both side thereof in order to create a more realistic and lifelike displays. Accordingly, color having a high reflectance such as silver or gray may be painted on the outer side of the light intercepting net member 11, while dark color such as black may be painted on the inner side thereof. This will prevents the inside temperature from rising,

Alternately, different patterns 161 may be respectively printed on both sides of the net member 11 according to the desired atmosphere to be created.

Even though the structural body 1 is exposed to the atmosphere where may receive strong rays of sunlight and undergo great changes in temperature, the printings 161 on the net member 11 are neither peeled off nor damaged due to the degradation stress thereof. The net member 11 formed by metals or plastic having such characteristics is coated with resin. Such coating not only prevents the net member 11 being destroyed by flexure, but also improves the bend of the intercepting net member 11, thus allowing the net member 11 to bend in order to form different portions of the structural body 1.

Furthermore, such coating may decrease the difference in level between the projections at the intersecting points and the adjacent concave portions such as the eyes 13 is being extruded out of the head of the beetle-shaped decorative lighting, thus enabling the net member 11 surface to be smoothed.

The illumination element 3 includes an ornament body 32 which may be a light emitting diode or simply a light bulb, and a socket 31 for holding the ornament body 32, the socket 31 is made from a material which is hot-melt resistant or high-temperature resistant, having an elastic clip 12 which is attached to the net support member 12 of the structural body 1.

Currently, in order to achieve the better decoration effect of the ornament body 32, the illumination element 3 is formed by a plurality of light strings or a single light string, each light string including a plurality of sockets 31 and a plurality of electrical wires 14, the sockets 31 are arranged properly and attached to the net support member 12 of the structural body 1. The net support member 12 provides the illumination elements 3 with a firm support, so that the illumination elements 3 can be held securely without wobbling even the structural body 1 is shaken by external forces. The illumination elements 3 have refraction surfaces to generate brilliant light to create steady visual effect.

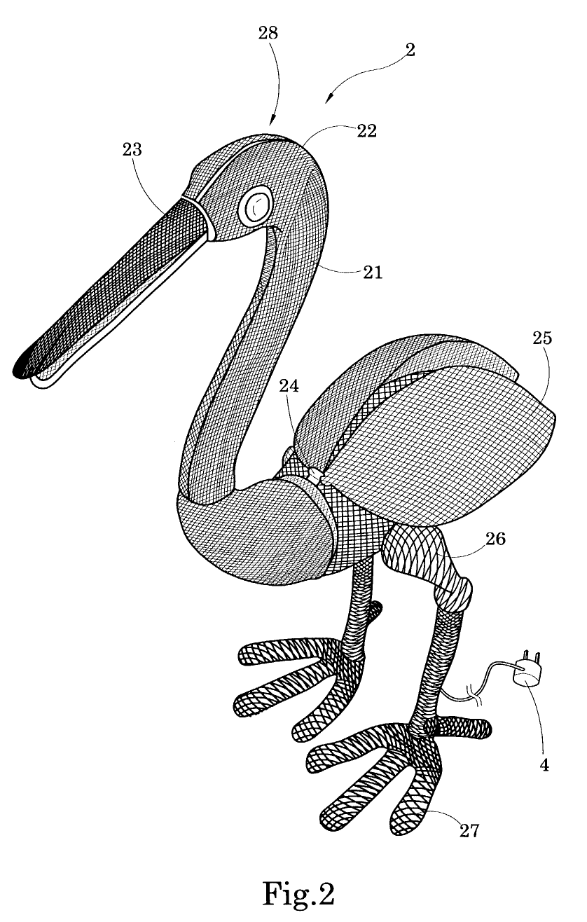

Refer to FIG. 2 for another example of the present invention. As shown in the drawings, the net member 11 can be shaped into the form of a figure, such as animal, plant, vehicle or character, here it shows a crane-shaped structural body 2, the crane-shaped decorative lighting which mainly includes a group of cross-layout grid net to form the arrangement of a net member 21, the edges of the above mentioned net member 21 is connected by a net support member 22. The net support member 22 forms a structural body 2 of the crane-shaped decorative lighting, which utilizes a proper jig to attach at least one illumination element 3 to a fixed position. Thus, it can simply and easily be assembled as a firm structure of the decorative lighting, and it can be placed on any level ground to obtain the best effectiveness.

When the electric plug 4 is switch to electricity, the structural body 2 of the crane-shaped decorative lighting will start to shine in order to convey an atmosphere of joy during celebration moments.

The net support member 22 may prevent the illumination element 3 and conductive wires 14 from wobbling or entangling, and prevent emitting light from scattering. As the structural body 2 is made from a hot-melt resistant or high temperature resistant material, refraction optical paths (not shown in the drawings) of light may be formed steadily. And based on parallax image formation principle that forms images on viewer's left and right eyes, overlapping and versatile cubical images may be generated to create brilliant lights and visual effect.

As a conclusion, the advantages of using net-shaped framework for three-dimensional decorative lightings are as follows:

1. The structural body 1 is injected to form a plurality of separate pieces, thus the plurality of separate pieces of said structural body 1 is connected by hinges or loose-leaf binders, or the structural body 1 can be separated from the plurality of auxiliary parts by separating the protruding members 18 from the receiving member 18′, thus allowing convenient assemble and disassemble the structural body.

2. The net member 11 are excellent in temperature, it increases the total surface area of the structural body 1, which allows excellent heat radiation to the surrounding environment and weather resisting properties as in resistance to compression or tension or stretchability and the like.

3. The net support member 12 provides the illumination elements 3 with a firm support, so that the illumination elements 3 can be held securely without wobbling even the structural body 1 is shaken by external forces. The illumination elements 3 have refraction surfaces to generate brilliant light to create steady visual effect.

4. The elastic clip 12 of the illumination element 3 can clip onto the net support member 12, thus allowing convenient assembling, exchanging or repairing the illumination element 3.

5. The three-dimensional decorative lightings having net-shaped framework can produce lifelike aspects, brilliant lights and visual effect which is more attractive than the conventional decorative lightings.

What is claimed is:

1. A net-shaped framework for three-dimensional decorative lightings, comprising:
a structural body being assembled by a net support member; and
a net member formed by a group of cross-layout grid net, which is attached to said net support member.

2. The net-shaped framework for three-dimensional decorative lightings of claim 1, wherein the structural body is person body-like shaped, animal body-like shaped, vehicle-like shaped.

3. The net-shaped framework for three-dimensional decorative lightings of claim 1, wherein the structural body can be injected to form a continuous piece.

4. The net-shaped framework for three-dimensional decorative lightings of claim 1, wherein the structural body can be injected to form a plurality of separate pieces.

5. The net-shaped framework for three-dimensional decorative lightings of claim 4, wherein the plurality of separate pieces of said structural body is connected by hinges.

6. The net-shaped framework for three-dimensional decorative lightings of claim 4, wherein the plurality of separate pieces of said structural body is connected by loose-leaf binders.

7. The net-shaped framework for three-dimensional decorative lightings of claim 1, wherein the structural body including a plurality of auxiliary parts.

8. The net-shaped framework for three-dimensional decorative lightings of claim 7, wherein the plurality of auxiliary parts are connected to the structural body by fasteners.

9. The net-shaped framework for three-dimensional decorative lightings of claim 8, wherein the fasteners are protruding members.

10. The net-shaped framework for three-dimensional decorative lightings of claim 1, wherein the net support member is form by wire.

11. The net-shaped framework for three-dimensional decorative lightings of claim 1, wherein the net member is formed by metal thin chip punching or stamping.

12. The net-shaped framework for three-dimensional decorative lightings of claim 1, wherein the net member is formed by plastic injection molding process.

13. The net-shaped framework for three-dimensional decorative lightings of claim 1, wherein the net member and the net support member is connected to each other by welding.

14. The net-shaped framework for three-dimensional decorative lightings of claim 1, wherein the net member is bound to the net support member.

15. The net-shaped framework for three-dimensional decorative lightings of claim 1, wherein the cross-layout grid net can be painted or drawn with colors or patterns at one side thereof.

16. The net-shaped framework for three-dimensional decorative lightings of claim 1, wherein the cross-layout grid net can be painted or drawn with colors or patterns at both side thereof.

17. The net-shaped framework for three-dimensional decorative lightings of claim 1, wherein the net member is made from a material which is hot-melt resistant or high-temperature resistant.

18. A net-shaped framework for three-dimensional decorative lightings, comprising:
a structural body being assembled by a net support member;
a net member formed by a group of cross-layout grid net, which is attached to said net support member; and
at least one illumination element mounted in said structural body.

19. The net-shaped framework for three-dimensional decorative lightings of claim 18, wherein the illumination element including an ornament body and a socket having an elastic clip located thereon.

20. The net-shaped framework for three-dimensional decorative lightings of claim 19, wherein the ornament body is a light bulb.

21. The net-shaped framework for three-dimensional decorative lightings of claim 19, wherein the ornament body is a light emitting diode.

22. The net-shaped framework for three-dimensional decorative lightings of claim 19, wherein the socket is made from a material which is hot-melt resistant or high-temperature resistant.

23. The net-shaped framework for three-dimensional decorative lightings of claim 19, wherein the elastic clip is attached to the net support member.
